(19) United States
(12) Patent Application Publication
(10) Pub. No.: US 2025/0046119 A1
(43) Pub. Date: Feb. 6, 2025

(54) METHOD AND SYSTEM FOR MANAGING WATCHING SERVICE

(71) Applicant: TOYOTA JIDOSHA KABUSHIKI KAISHA, Aichi-ken (JP)

(72) Inventor: Koki SONE, Taito-ku (JP)

(21) Appl. No.: 18/773,577

(22) Filed: Jul. 16, 2024

(30) Foreign Application Priority Data
Jul. 31, 2023 (JP) 2023-124031

(51) Int. Cl. G06V 40/16

(52) U.S. Cl. CPC G06V 40/161

(57) ABSTRACT

When receiving an application for use of a watching service from a communication terminal of the user of the watching service, a management server sends a request for personal identification to a communication terminal of a watching target of the user. When receiving information that meets the request for personal identification from the communication terminal of the watching target, an image of an infrastructure camera including the watching target is allowed to be sent to the communication terminal of the user. The request for personal identification includes photographing a face portion of the watching target by using the communication terminal of the watching target, and sending a shot image of the face portion from the communication terminal of the watching target to the management server.

### CROSS-REFERENCE TO RELATED APPLICATION

The present application claims priority under 35 U.S.C. § 119 to Japanese Patent Application No. 2023-124031, filed on Jul. 31, 2023, the contents of which application are incorporated herein by reference in their entirety.

### TECHNICAL FIELD

The present disclosure relates to a method and a system for managing a service of providing an image of an infrastructure camera including an image of a watching target to a communication terminal of a user or the service.

### BACKGROUND

JP2002197565A discloses a server that provides an image of a child in a facility to a guardian of the child at a remote location. In the related art, when the server receives a request for provision of information on the child from a terminal of the guardian, the server authenticates whether the request is valid. In this authentication, a number registered in advance in the server is collated with that of the terminal of the guardian. When the request is valid as a result of the collation, the server specifies an image including the image of the child related to the request from among images of a camera provided in the facility and transmits the specified image to the terminal of the guardian.

Examples of document showing the technical level of the art relevant to the present disclosure include JP2007060528A, JP2004356816A and JP2006107187A, in addition to JP2002197565A.

Consider a “watching service” in which a plurality of infrastructure cameras installed indoors and outdoors are used to provide an image of an infrastructure camera including an image of a watching target to a communication terminal of a user. Here, in a limited space such as the child keeping facility, the persons that can be included in the camera image are limited, whereas there is no such limitation indoors and outdoors. Therefore, key information is considered to be necessary in order to identify a camera image including the image of the watching target from among camera images acquired by the plurality of infrastructure cameras.

For example, an image (e.g., a face photo) including the feature of the watching target is registered in the server, and when a service use request is received from the terminal of the user, the server searches for the watching target using the registered image as the key information. This makes it possible to identify the camera image including the watching target from the camera images acquired by the plurality of infrastructure cameras and provide the identified camera image to the communication terminal of the user.

In the “watching service”, it is considered that the consent for watching is obtained from the watching target. This is because the watching target in the “watching service” is assumed to be a person who behaves indoors and outdoors by his/her own will. As a means for obtaining the consent for watching, an approval by the watching target using a communication terminal carried by the watching target is assumed.

According to the server of the related art, the authentication of the request can prevent the image of the child related to the request from being provided to the third-party who pretends to be the guardian. It is desirable that this spoofing of the third-party is prevented also in the “watching service”. However, under the above-described premise of the “watching service”, if the registered image as the key information is illegally obtained by the third-party, the image including the watching target may be provided to the third-party who impersonates the user. Therefore, there is a need for technology development for preventing such a spoofing and appropriately operating the “watching service”.

An object of the present disclosure is to provide a technique capable of preventing a spoofing by a third-party and appropriately operating a service for providing an image of an infrastructure camera including an image of a watching target to a communication terminal of a user.

### SUMMARY

A first aspect of the present disclosure is a method for managing a watching service using an infrastructure camera and has the following features.

The method comprising:
when receiving an application for use of the watching service from a communication terminal of a user, a management server sending a request for personal identification to a communication terminal of a watching target of the user; and
when receiving information satisfying the request for personal identification from the communication terminal of the watching target, the management server allowing a sending an image of the infrastructure camera including the watching target to the communication terminal of the user.

The request for personal identification includes photographing a face portion of the watching target by using the communication terminal of the watching target and sending a shot image of the face portion from the communication terminal of the watching target to the management server.

A second aspect of the present disclosure is a system for managing a watching service and has the following features.

The system comprises a communication terminal of a user of the watching service, a communication terminal of a watching target of the user, and a management server communicating with the communication terminals of the user and the watching target.

The management server is configured to:
when receiving an application for use of the watching service from the communication terminal of the user, send a request for personal identification to the communication terminal of the watching target; and
when receiving information satisfying the request for personal identification from the communication terminal of the watching target, allow a sending an image of the infrastructure camera including the watching target to the communication terminal of the user.

The request for personal identification includes photographing a face portion of the watching target by using the communication terminal of the watching target and sending a shot image of the face portion from the communication terminal of the watching target to the management server.

According to the present disclosure, it is possible to avoid providing an image of the infrastructure camera including an image of the watching target to a third-party who is pretending to be at least one of the watching target and the user of the watching service.

Therefore, the watching service can be appropriately operated.

### BRIEF DESCRIPTION OF DRAWINGS

FIG. 1 is a diagram for illustrating an outline of a watching service;

FIG. 2 is a diagram for illustrating a problem in the watching service;

FIG. 3 is a diagram for illustrating a countermeasure example against the problem illustrated in FIG. 2;

FIG. 4 is a diagram for illustrating another problem in the watching service;

FIG. 5 is a diagram for illustrating a countermeasure against a spoofing according to an embodiment;

FIG. 6 is a flowchart showing a processing example particularly related to the embodiment executed a management server;

FIG. 7 is a flowchart showing a processing example particularly related to the embodiment executed by the management server;

FIG. 8 is a flowchart illustrating a first processing example related to a registration of a new terminal executed by the management server; and

FIG. 9 is a flowchart showing a second processing example related to the registration of the new terminal executed by the management server.

### DESCRIPTION OF EMBODIMENT

Hereinafter, an embodiment of the present disclosure will be described with reference to the drawings. In the drawings, the same or corresponding parts are denoted by the same reference numerals, and the description thereof will be simplified or omitted.

### 1. Watching Service

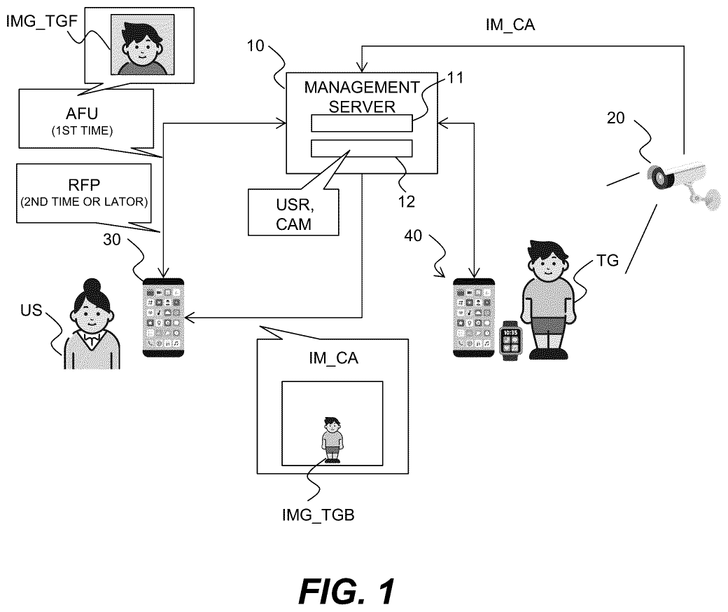

FIG. 1 is a diagram for illustrating an outline of a watching service. The watching service is a service for specifying a camera image IM_CA including an image IMG_TG of a watching target TG (a whole-body image IMG_TGB in the example shown in FIG. 1) from among camera images IM_CA acquired by a plurality of infrastructure cameras constituting the infrastructure cameras 20, and providing the specified camera image IM_CA to a communication terminal (hereinafter, also referred to as a “user terminal”) 30 of the user US. Here, the user US is a person who uses the watching service. The watching target TG is a person (for example, a family of the user US, a friend of the user US, or a person cared by the user US) that the user US wants to watch.

FIG. 1 is also a diagram for illustrating an example of an overall configuration of a system for managing the watching service according to the embodiment. In the example shown in FIG. 1, the management system includes a management server 10, infrastructure cameras 20, a user terminal 30, and a communication terminal (hereinafter, also referred to as a “target terminal”) 40 of the watching target TG. The infrastructure cameras 20, the user terminal 30, and the target terminal 40 communicate with the management server 10 via a communication network (not shown). The communication network is not particularly limited, and a wired or wireless network is used.

The management server 10 includes a data processing device 11 and a database 12. The data processing device 11 includes at least one processor and at least one memory. The processor includes a central processing unit (CPU). The memory is a volatile memory such as a DDR memory, and develops various programs used in various processing executed by the processor and temporarily stores various data. The various data used by the processor includes data stored in the database 12.

The database 12 is formed in a predetermined memory device (for example, a hard disk or a flash memory). The database 12 stores user data USR and camera data CAM. The user data USR is transmitted from the user terminal 30 to the management server 10. The user data USR includes identification information of the user US, identification information of the watching target TG, and the like. The camera data CAM includes identification information of each of the plurality of infrastructure cameras constituting the infrastructure cameras 20, positional information of these infrastructure cameras, camera images IM_CA acquired by these infrastructure cameras, and the like.

The infrastructure cameras 20 include a plurality of infrastructure cameras. These infrastructure cameras include not only an infrastructure camera installed outdoors but also an infrastructure camera installed indoors. A part or all of the imaging ranges of two or more infrastructure cameras may overlap. Each Infrastructure camera acquires a camera image IM_CA. The camera image IM_CA is typically a moving image, but may be a still image. Each infrastructure camera also transmits the acquired camera image IM_CA to the management server 10 together with its own identification information.

The user terminal 30 is a terminal having a communication function, such as a smartphone, a tablet, or a notebook computer carried by the user US. The user terminal 30 is used when the user US uses the watching service for the first time. At the time of first use, an application AFU (Application For Use) for use of the watching service is transmitted from the user terminal 30 to the management server 10. The application AFU includes user data USR including identification information of the user US, identification information of the watching target TG, and the like. When the user data USR is registered in the database 12, the watching service can be used.

Examples of the identification information of the user US include attribute information (for example, name, gender, and age) of the user US and identification information of the user terminal 30. As the identification information of the watching target TG, face Image IMG_TGF of the watching target TG is exemplified. The face image IMG_TGF is information particularly necessary for watching the watching target TG. Therefore, when the application AFU in which the face Image IMG_TGF is missing is received, the management server 10 may request the user terminal 30 to transmit the shot image of the face portion of the watching target TG before registering the user data USR included in the application AFU in the database 12. The identification information of the watching target terminal 40 may include identification information of the target TG and relationship information between the user US and the watching target TG (for example, family, friends, and people cared by the user US).

The user terminal 30 is also used when the user US uses the watching service for the second time or later. When the user terminal 30 is used for the second time or later, a request for provision RFP (Request For Provision) of information on the watching target TG is transmitted from the user terminal 30 to the management server 10. The request RFP includes, for example, login information of the user US for accessing the database 12. Information for updating a part or all of the data of the user data USR registered in the database 12 may be transmitted to the request RFP. When such update information is included in the request RFP, the user data USR registered in the database 12 is updated.

The target terminal 40 is a terminal having communication functions, such as smartphones and wearable devices carried by the watching target TG. The target terminal 40 also has a camera function. By having the communication and camera functions, the target terminal 40 transmits a camera image captured by the target terminal 40 to an external device (for example, the management server 10 or the user terminal 30). The target terminal 40 may have a global positioning system (GPS) function. With the GPS function, the target terminal 40 transmits positional information of the target terminal 40 to an external device.

### 2. Features of Embodiment

### 2-1. Problem in Watching Service

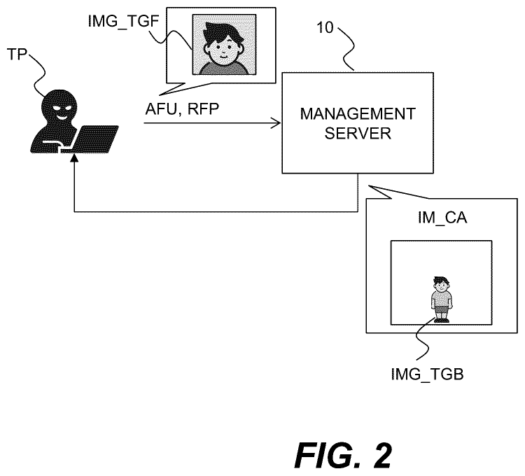

FIG. 2 is a diagram for illustrating the problem in the watching service. In the watching service described in FIG. 1, the face image IMG_TGF of the watching target TG is included in the application AFU. Therefore, it is also considered that the application AFU by the third-party TP having no relation with the watching target TG can be excluded. However, it is possible for the third-party TP to obtain the face Image IMG_TGF by some method. Then, when the third-party TP who has obtained the face image IMG_TGF impersonates the user US and performs the application AFU and the request RFP with malicious intent, the third-party TP can view the camera image IM_CA including the image IMG_TG.

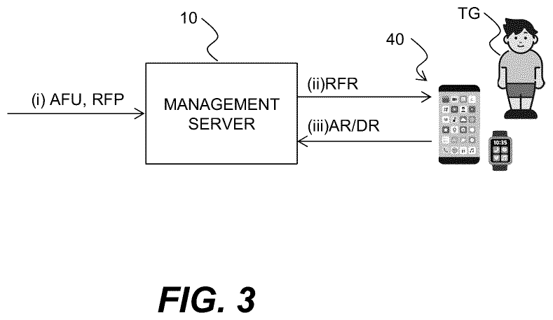

FIG. 3 is a diagram for illustrating a countermeasure example against the problem described in FIG. 2. In the countermeasure example shown in FIG. 3, when the management server 10 receives the request RFP, a request for reply RFR (Request For Reply) to the request RFP is transmitted from the management server 10 to the target terminal 40. If the target terminal 40 sends an Approve Reply indicating approval of the information, the user US who has sent the request RFP is provided with the camera image IM_CA including the image IMG_TG. On the other hand, when the response DR (Disapprove Reply) not approving the provision of the information is received from the target terminal 40, the camera image IM_CA is not provided. If there is no response to the request RFR, the camera image IM_CA is not provided.

### 2-2. Another Problem in Watching Service

According to the countermeasure example described in FIG. 3, the watching target TG can operate the target terminal 40 to transmit the response RTR. Therefore, for example, when the watching target terminal 40 determines that there is a request RFP from a malicious third-party TP from the situation of the watching target TP when the target TP receives the request RFR, it is possible to avoid providing the camera image IM_CA to the third-party TP by not responding to the request RFR or by transmitting the response DR.

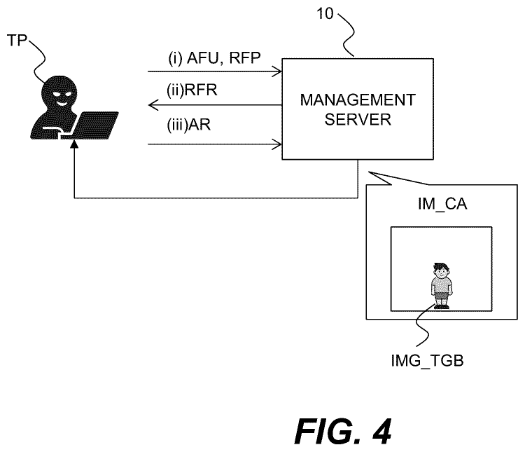

However, a case is conceivable where the third-party TP impersonates the user US and the watching target TG. FIG. 4 is a diagram for illustrating another problem in the watching service. In the example shown in FIG. 4, the third-party TP transmits the application AFU and the request RFP. In addition, the third-party TP transmits the response AR to the request RFR transmitted by the management server 10 that has received the request RFP. When such spoofing is performed, the camera image IM_CA including the image IMG_TG is provided to the third-party TP.

### 2-3. Request for Personal Identification

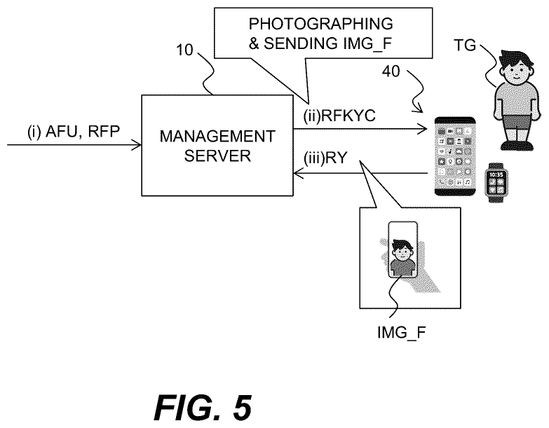

In view of these problems, in the embodiment, when the management server 10 receives the application AFU, the management server 10 transmits a request RFKYC (Request For Know Your Customer) of personal identification to the target terminal 40. FIG. 5 is a diagram for illustrating a countermeasure against the spoofing according to the embodiment. In the example shown in FIG. 5, the management server 10 that has received the application AFU transmits the request RFKYC to the target terminal 40. In this example, the request RFKYC including the acquisition of the shot image IMG_F of the face portion of the person himself/herself using the built-in camera of the target terminal 40 and the transmission of the shot image IMG_F using the target terminal 40 is transmitted to the target terminal 40.

When the target terminal 40 receives the request RFKYC, the watching target TG first takes an image of its face portion according to the request RFKYC and sends a shot image IMG_F. Then, the management server 10 can determine that the series of operations executed in accordance with the request RFKYC is executed by the watching target TG.

The mechanism of online personal identification (electric Know Your Customer) is known per se. However, according to the method shown in FIG. 5, the request RFKYC is transmitted to the target terminal 40 in response to the application AFU from the user terminal 30, and the personal identification using the shot image IMG_F from the target terminal 40 is executed. Then, if the transmission of the camera image IM_CA to the user terminal 30 is permitted when the information satisfying the request RFKYC (that is, the shot image IMG_F) is obtained, it is possible to avoid the camera image IM_CA including the image IMG_TG from being provided to the user US and the third-party TP who impersonates the watching target TG.

In the method shown in FIG. 5, the request RFKYC including the photographing of the shot image IMG_F of the face portion of the person himself/herself and the transmission of the shot image IMG_F is transmitted to the target terminal 40. The photographing of the shot image IMG_F of the face portion may be photographing of a desired action (head shaking operation) in which the face portion is moved a random number of times in a random direction (for example, three times to the right, left, and left). In this case, the shot image IMG_F obtained by the imaging of the desired action is obtained as information satisfying the request RFKYC. Therefore, the accuracy of personal identification can be improved.

### 2-4. Request for Association

In the embodiment, when the management server 10 receives the application AFU, a request for association RFA (Request For Association) may be transmitted from the management server 10 to the user terminal 30. The request RFA is a request for associating a new communication terminal (hereinafter, also referred to as a “new terminal”) with the user terminal 30. Then, when information satisfying the request RFA is obtained, the new communication terminal may be registered as the target terminal 40 based on this information.

As described above, the application AFU may include identification information of the target terminal 40 as identification information of the watching target TG. By acquiring the identification information of the target terminal 40 in response to the request RFA, it is possible to reduce the time and effort of the user US required for the registration of the target terminal 40. In addition, if the target terminal 40 is registered based on the request RFA, it is expected that the effect of avoiding the provision of the camera image IM_CA to the third-party TP is enhanced by combining the target IP address with the method using the request RFKYC described above.

In the first example, the request RFA includes acquisition of the terminal information TID of the new terminal by the short distance communication between the user terminal 30 and the new terminal, and transmission of the terminal information TID from the user terminal 30 to the management server 10. In the first example, it is assumed that the user terminal 30 and the new terminal exist in the same space when the application AFU is transmitted. Therefore, according to the first example, it is possible to exclude the application AFU by the third-party TP that attempts to acquire the camera image IM_CA including the image IMG_TG by using a single communication terminal.

In the second example, the request RFA includes reading of the connection information CNC output from the user terminal 30 by the new terminal and connection to the management server 10 by the new terminal based on the connection information CNC. The connection information CNC is information of a connection point of the management server 10 (that is, the management server 10). The output of the connection information CNC from the user terminal 30 is performed by, for example, displaying a QR code (registered trademark) representing the connection information CNC on the display of the user terminal 30. In the second example, it is also assumed that the user terminal 30 and the new terminal exist in the same space when the application AFU is transmitted. Therefore, according to the second example, the same effect as the first example is expected.

### 3. Processing Example by Management Server

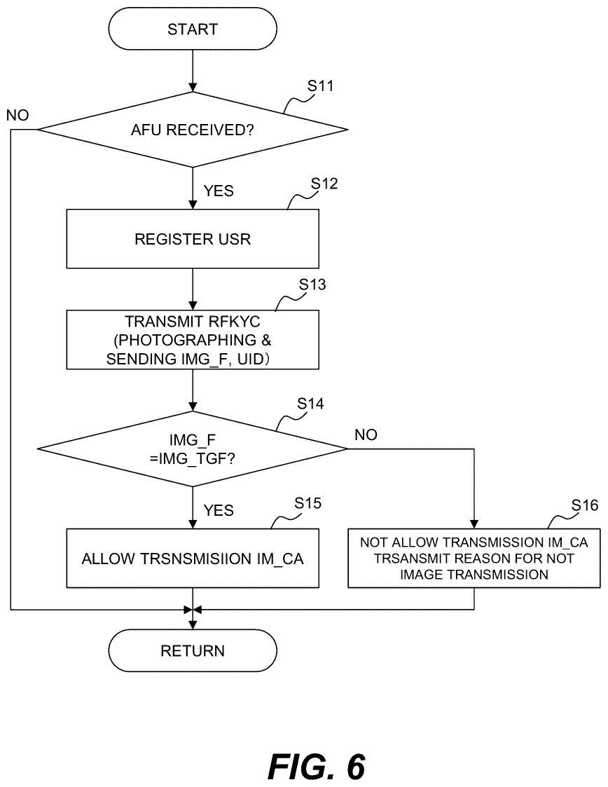

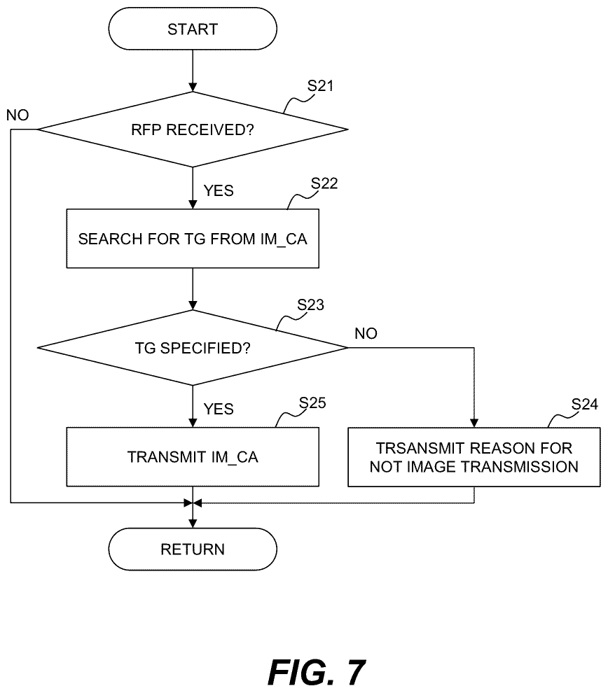

FIGS. 6 and 7 are flowcharts showing processing examples executed by the management server 10 (the processor of the data processing device 11), which are particularly related to the embodiment. The routines shown in FIGS. 6 and 7 are repeatedly executed at predetermined intervals, for example.

In the routine shown in FIG. 6, it is first determined whether an application AFU has been received (step S11). If the judgment result in step S11 is positive, the processing of step S12 is executed. In the processing of step S12, the user data USR (the face image IMG_TGF, etc.) included in the application AFU acquired in the processing of step S11 is registered in the database 12.

Subsequent to the processing of step S12, the processing of step S13 is executed. In the processing of step S13, request RFKYC is transmitted to the target terminal 40. As described above, the request RFKYC includes the acquisition of the shot image IMG_F of the face portion of the person himself/herself and the transmission of the shot image IMG_F.

In the example shown in FIG. 6, the identification information UID is transmitted together with the request RFKYC in the processing of step S13. The identification information UID is information unique to the user terminal 30 and is arbitrarily added to the request RFKYC. As the identification information UID, a password set between the user US and the watching target TG is exemplified. The identification information UID is added, for example, when the request RFP is transmitted. According to such identification information UID, it is possible to provide the watching target terminal 40 with information for determining that the request RFKYC transmitted to the target TP is not transmitted in response to the request RFP by the third-party TP. Further, in the case where there are a plurality of users US who desire to watch over the watching target TG, the identification information UID is changed for each user US, whereby the watching target TG can estimate who the user US who has transmitted the request RFP is.

Subsequent to the processing of step S13, the processing of step S14 is executed. In the processing of step S14, the shot image IMG_F received from the UE 40 in response to the processing of step S13 is compared with the face image IMG_TGF included in the user data USR received in the processing of step S11. Then, when the shot image IMG_F and the face image IMG_TGF match, the judgment result in step S14 is positive. If the judgment result in step S14 is positive, the processing of step S15 is executed. In the processing of step S15, the camera image IM_CA is permitted to be transmitted to the user terminal 30.

If the judgment result in step S14 is negative, the processing of step S16 is executed. In the processing of step S16, the camera image IM_CA is not allowed to be transmitted to the user terminal 30. Further, the reason why the transmission is not permitted is transmitted to the terminal (for example, the user terminal 30 or the communication terminal of the third-party TP) of the transmission source of the application AFU. The reason for this is exemplified by the fact that the shot image IMG_F and the face image IMG_TGF do not match.

In the routine shown in FIG. 7, first, it is determined whether a request RFP has been received (step S21). As described above, the request RFP includes the login information of the user US for accessing the database 12. If the judgment result in step S21 is positive, the processing of step S22 is executed.

In the processing of step S22, the camera image IM_CA stored in the database 12 is searched for the watching target TG. In this search, the database 12 is searched using the login information received in the processing of step S21 as a key, and the face image IMG_TGF included in the user data USR corresponding to the login information is specified. Then, the database 12 is searched using the face image IMG_TGF as a key, and the camera image IM_CA including the image of the person matching the person of the face image IMG_TGF and the infrastructure camera that has acquired the camera image IM_CA are specified. The specified camera image IM_CA is a camera image closest to the current time, that is, the latest camera image.

It is assumed that the watching target TG continues to move. Therefore, the processing of step S22 is repeatedly executed. Thus, the Infrastructure camera that has acquired the camera image IM_CA including the image of the person matching the person of the face Image IMG_TGF is repeatedly specified. The total number of specified Infrastructure cameras may be two or more. This is because, when the imaging ranges of two or more infrastructure cameras partially or entirely overlap, the camera images IM_CA including the image of the person matching the person of the face image IMG_TGF may be separately acquired by these infrastructure cameras.

If positional information of the target terminal 40 can be used, the processing of step S22 may narrow down the infrastructure cameras for searching for the watching target TG by using the positional information. In this narrowing down, at least one infrastructure camera installed near the actual position of the target terminal 40 is extracted. Then, the camera image IM_CA including the image of the person matching the person of the face image IMG_TGF is specified from the camera image IM_CA of the at least one infrastructure camera.

Subsequent to the processing of step S22, the processing of step S23 is executed. In the processing of step S23, it is determined whether the watching target TG have been specified. If the judgment result in step S23 is negative, the processing of step S24 is executed. In the processing of step S24, the reason why the camera image IM_CA is not transmitted is transmitted to the user device 30 that is the transmission source of the request RFP. The reason for this is exemplified by the fact that the watching target TG could not be specified.

If the judgment result in step S23 is positive, the processing of step S25 is executed. In the processing of step S25, the camera image IM_CA is transmitted to the user device 30 that is the transmission source of the request RFP.

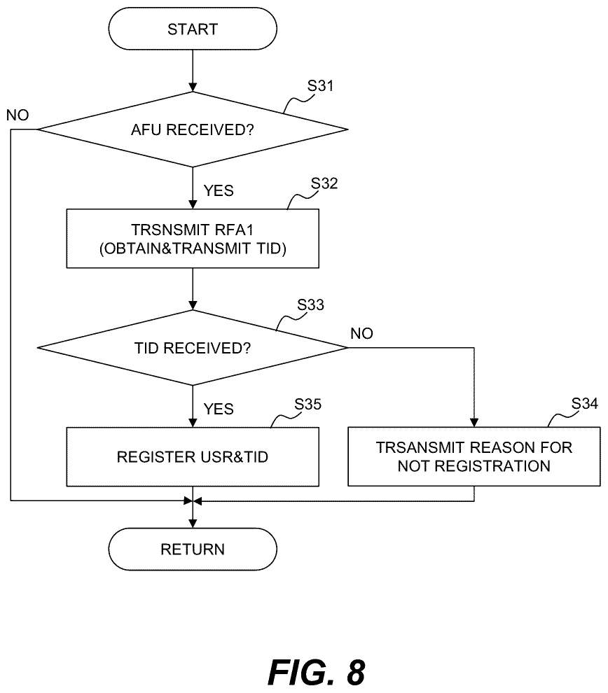

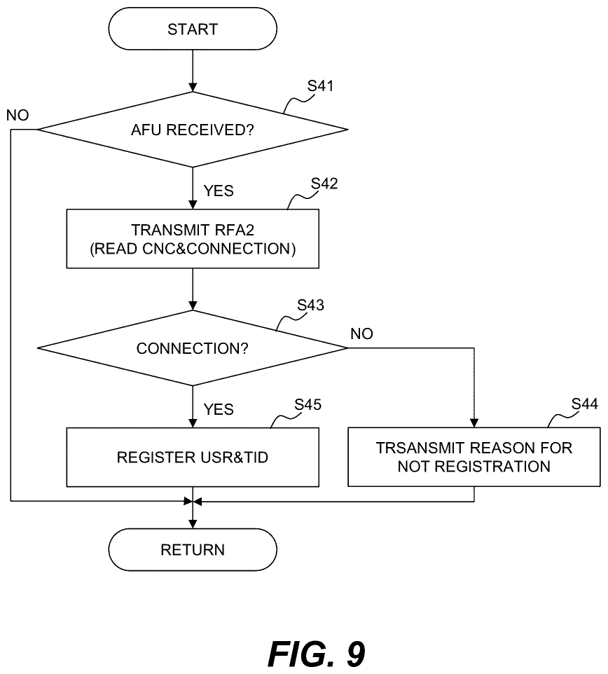

FIGS. 8 and 9 are flowcharts showing a first and a second processing examples related to a registration of a new terminal executed by the management server 10 (the processor of the data processing device 11). The routines shown in FIGS. 8 and 9 are executed instead of the processing of steps S11 and 12 shown in FIG. 6, or are executed in parallel with the execution of the processing of steps S11 and 12. The routines shown in FIGS. 8 and 9 are repeatedly executed at predetermined intervals, for example.

In the example shown in FIG. 8, first, it is determined whether an application AFU has been received (step S31). If the judgment result in step S31 is positive, the processing of step S32 is executed. In the processing of step S32, a request for association RFA1 is transmitted. The request RFA1 includes the acquisition of the device information TID and the transmission of the device information TID from the user terminal 30 to the management server 10.

Subsequent to the processing of step S32, it is determined whether the device information TID has been received (step S33). The processing of step S33 is executed based on, for example, whether the management server 10 has received the device information TID before a predetermined time (for example, 1 to 2 minutes) elapses from the time when the processing of step S22 is executed. If the judgment result in step S33 is negative, the processing of step S34 is executed. In the processing of step S34, the reason why the registration of the new terminal is not permitted is transmitted to the terminals (for example, the user terminal 30 and the communication terminals of the third-party TP) which are the transmission sources of the application AFU. The reason for this is exemplified by the fact that the terminal information TID is not transmitted.

If the judgment result in step S33 is positive, the processing of step S35 is executed. In the processing of step S35, the device information TID acquired in the processing of step S33 is registered in the database 12 together with the user data USR (face image IMG_TGF, etc.) included in the application AFU acquired in the processing of step S31.

In the example shown in FIG. 9, first, it is determined whether an application AFU has been received (step S41). If the judgment result in step S41 is positive, the processing of step S42 is executed. In the processing of step S42, a request for association RFA2 is transmitted. The request RFA2 includes reading of the connection information CNC output from the user terminal 30 by the new terminal and connection to the management server 10 by the new terminal based on the connection information CNC.

Subsequent to the processing of step S42, the processing of step S43 is executed. In the processing of step S43, it is determined whether a connection from the new terminal has been made. The processing of step S43 is executed based on, for example, whether a connection from the new terminal to the management server 10 has been made before a predetermined time (for example, 1 to 2 minutes) elapses from the time when the processing of step S42 is executed. If the judgment result in step S43 is negative, the processing of step S44 is executed. In the processing of step S44, the reason why the registration of the new terminal is not permitted is transmitted to the terminals (for example, the user terminal 30 and the communication terminals of the third-party TP) which are the transmission sources of the application AFU. The reason for this is exemplified by the fact that there is no connection from the new terminal.

If the judgment result in step S43 is positive, the processing of step S45 is executed. In the processing of step S45, the device information (that is, the device information TID) of the new device connected to the management server 10 in the processing of step S43 is registered in the database 12 together with the user data USR (the face image IMG_TGF and the like) included in the application AFU acquired in the processing of step S41.

What is claimed is:

1. A method for managing a watching service using an infrastructure camera, the method comprising:
when receiving an application for use of the watching service from a communication terminal of a user, a management server sending a request for personal identification to a communication terminal of a watching target of the user; and
when receiving information satisfying the request for personal identification from the communication terminal of the watching target, the management server allowing a sending an image of the infrastructure camera including the watching target to the communication terminal of the user,
wherein the request for personal identification includes photographing a face portion of the watching target by using the communication terminal of the watching target and sending a shot image of the face portion from the communication terminal of the watching target to the management server.

2. The method according to claim 1,
wherein a photographing request of the face portion included in the request for personal identification includes a photographing of a desired action for the face portion.

3. The method according to claim 1,
wherein the method further comprising:
when receiving an application for use of the watching service from the communication terminal of the user, the management sever sending a request for association for registering a new communication terminal to be associated with the communication terminal of the user to the communication terminal of the user; and
when receiving information satisfying the request for association from the communication terminal of the user or the new communication terminal, the management server registering the new communication terminal as the communication terminal of the watching target in accordance with the information satisfying the request for association.

4. The method according to claim 3,
wherein the request for association includes acquiring terminal information of the new communication terminal through short distance communication between the communication terminal of the user and the new communication terminal and sending the terminal information of the new communication terminal to the management server.

5. The method according to claim 3,
wherein the request for association includes reading, by the new communication terminal, connection information output from the communication terminal of the user and connecting, by the new communication terminal, to the management server based on the connection information.

6. A system for managing a watching service using an infrastructure camera, the system comprising;
a communication terminal of a user of the watching service;
a communication terminal of a watching target of the user; and
a management server communicating with the communication terminals of the user and the watching target,
wherein the management server is configured to:
when receiving an application for use of the watching service from the communication terminal of the user, send a request for personal identification to the communication terminal of the watching target; and
when receiving information satisfying the request for personal identification from the communication terminal of the watching target, allow a sending an image of the infrastructure camera including the watching target to the communication terminal of the user,
wherein the request for personal identification includes photographing a face portion of the watching target by using the communication terminal of the watching target and sending a shot image of the face portion from the communication terminal of the watching target to the management server.
